(19) United States
(12) Patent Application Publication
(10) Pub. No.: US 2026/0030705 A1
(43) Pub. Date: Jan. 29, 2026

(54) TAXONOMICALLY GROUPING TRADITIONAL ARTS AND SPORTS BY APPLYING EMBODIED-COGNITION

(71) Applicants: Satheeshkumar NAMASIVAYAM, Bommayarpalayam Villupuram (IN); Bade KUCUKOGLU NAMASIVAYAM, Bommayarpalayam Villupuram (IN)

(72) Inventors: Satheeshkumar NAMASIVAYAM, Bommayarpalayam Villupuram (IN); Bade KUCUKOGLU NAMASIVAYAM, Bommayarpalayam Villupuram (IN)

(21) Appl. No.: 19/238,629

(22) Filed: Jun. 16, 2025

(30) Foreign Application Priority Data
Jul. 29, 2024 (IN) 202441057498

(51) Int. Cl. G06Q 50/20

(52) U.S. Cl. CPC G06Q 50/205

(57) ABSTRACT

Approaches for a learning management system and a method for implementing targeted learning, is described. In an example, a learning outcome may be selected. In one example, the learning outcome may correspond to obtaining a learning objective. Further, one or more learning activities may be identified corresponding to achieving the learning outcome. In one example, the learning activities are categorized to obtain a target feature, with extracted feature(s) from traditional and traditional sports by applying the science of embodied cognition. Further, each of the plurality of learning activities may be correlated with each of the target features based on a pre-defined criterion based on the learning activity, which leads to achieving the learning objective.

### BACKGROUND

Worldwide, education of young adolescent children is at a crossroads. On the one hand, science and technology is advancing at breakneck speed; but, on the other hand—as well-documented by many international organizations such as the WHO and leading social-psychologists—there is an unprecedented mental health crisis of young adolescent children. As has been reported, one in seven children between the age of 10-19 are currently experiencing mental health disease. Similarly, it has been reported based on global surveys of adolescents that “75% of young respondents believe ‘the future is frightening’—jumping to 81% of youth surveyed in Portugal; and 92% in the Philippines”. In addition, reports also show the epidemic of mental illness among young adolescents of the United States.

However, children in many ancient cultures around the world—such as in Indian, Thai or African cultures—do not report similar levels of mental health crisis at a young age. They learn traditional arts (including but not limited to art, music, dance and theater) and traditional sports at a formative age that are specifically helping children both to discover themselves as individuals and to explore themselves in relation to the world. These traditional arts and traditional sports also help children therapeutically express their emotions in creative ways during their adolescence.

### BRIEF DESCRIPTION OF FIGURES

Systems and/or methods, in accordance with examples of the present subject matter are now described and with reference to the accompanying figures, in which:

FIG. 1 illustrates an example learning management system for implementing targeted learning, as per an example of the present subject matter;

FIG. 2 illustrates an example learning management system for implementing targeted learning, as per another example of the present subject matter; and

FIG. 3 illustrates a method for implementing targeted learning, for example, as per an example of the present subject matter.

It may be noted that throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As may be understood, innovative teaching methods comprise of creativity and novelty of the educator which changes the style and method of teaching and re-defines classroom experience for effective learning. The use of innovative methods in educational institutions has the potential not only to improve education, but also to empower people; enable them to lead happier lives; galvanize the effort to achieve the human development goal for the country and contribute to a more peaceful world.

Globally, educational institutions have been implementing new ideas, methods, technology-based innovations to enhance the students' knowledge and learning since innovative teaching is necessary for the present and future of education to help students to reach their full potential. However, it is well known that higher education should serve the long-term needs of students for them to discover themselves and to gain new insights about the world; including opening up new channels of intellectual stimulation for enhanced essential and creative thinking skills. Innovative teaching is a necessity for all teachers to meet the educational needs of the new generations.

Further, mental well-being is a critical aspect and is particularly important for students as they encounter challenges of transitioning to adulthood apart from pressurizing academic life and social expectations. Currently, the global health data of children between the ages of 10-19 years shows mental health diseases at a tender age. Students who struggle with mental health problems generally find it difficult to succeed academically and may also face difficulties with maintaining relationships with peers, family, and friends, since adolescence is a unique and a formative time for a child in terms of physical, emotional, and social changes. It is, therefore, crucial to protect adolescents from adversaries by promoting socio-economic learning and phycological well-being, thereby ensuring mental health care.

It is pertinent to note that school curriculums around the world only focus on cognitive science-based learning, specifically based on linguistic teaching methods. Further, traditional arts and traditional sports in various cultures, over the centuries, have been taught for specific targeted outcomes such as a performance, ceremony, ritual, or an enactment etc. Other benefits such as psychological wellbeing; or knowing oneself better; or relating with the world more peacefully; have all not been targeted as end goals of learning traditional arts and sports. Such benefits, if any, have been relegated to be unintended byproducts of learning traditional arts and sports. This has been so because, until in the recent past, there has never been a scientific method or system either to taxonomically group specific traditional arts and sports for specific targeted educational outcomes (other than performance, ceremony, ritual, enactment etc.) or to extract specific features from different arts and sports to combine them for specific targeted educational outcomes.

However, the emerging science of Embodied Cognition, specifically Enactivism, offers a pathway to improve on traditional arts for such targeted educational outcomes. By applying the science of Embodied Cognition, it is now possible to create a method and system to both taxonomically group traditional arts and sports; and to combine extracted features/elements from many disparate traditional arts and sports for implementing targeted learning outcomes.

Although, there have been studies suggesting embodied cognition for recognizing mental imagery, particularly, automatic simulation varieties as a core mechanism for deep conceptual processing rather than just linguistic based techniques, there hasn't been a direct taxonomical grouping of traditional arts and sports by applying the science of embodied cognition to achieve both the wholistic development of children and their well-being. Further, there hasn't been extraction of features of traditional arts and sports using the emerging science and its mapping to specific learning outcomes and objectives, thus enabling traditional arts and sports to be taught to achieve targeted learning outcomes—such as to develop inner consciousness and to augment interconnectedness with the world.

Approaches for taxonomically grouping traditional arts and sports to implement targeted learning are described. The present subject matter provides effective approaches for mapping traditional expressive cultural art forms into the emerging science of embodied cognition using a two-dimensional approach wherein a learning outcome is targeted as a goal to achieve a specific learning objective. The learning objective is associated with certain specific learning activities corresponding to body, mind, heart, and soul of a person, mapping of which leads to exploring an inner consciousness, embracing an inter-connectedness, and deepening oneness.

In an example, a system may be initiated to select a learning outcome. In one example, the learning outcome may correspond to obtaining a learning objective. However, to obtain the learning objective, the system may be initiated to identify one or more learning activities. It may be noted that each learning activity is associated with the learning objective.

Continuing further, the one or more learning activities may be based on one of a type, a form, and a prospect of the learning activity. In one example, the learning activities are categorized to obtain a target feature which may be associated with an ambit comprising body, mind, heart, and spirit of a user. Further, each of the plurality of learning activities may be correlated with each of the target features based on a pre-defined criterion, wherein correlating the learning activity with the target feature corresponds to activating the target feature based on the learning activity, which ultimately leads to obtaining the learning objective. The pre-defined criterion for correlating the learning activity with the target feature corresponds to determining whether the learning activity comprises an individual or a group of individuals, for example, whether a single student may be able to perform the learning activity, or a group of students are required to perform the learning activity.

In one example, the type, form, and prospect of the learning activity may correspond to determining whether the learning activity is one of a performance, an enactment, a ceremony, a ritual, or combinations thereof. In one example, the learning activity may correspond to a learning pursuit selected from one of an art learning pursuit, a music learning pursuit, a dance learning pursuit, a theatrical learning pursuit, a sports learning pursuit, or combinations thereof. In the present context, prospect of the learning activity pertains to feasibility and availability of a specific learning activity in a geographical area and based on whether any educational institution is equipped with means to incorporate the specific activity into the curriculum of the students.

However, it may be noted that identification of a learning activity based geographical area may be construed as a mere example, and not a limitation of the present subject matter. Further, correlation based on the pre-defined criterion plays a crucial role in achieving the learning objective since each of the learning outcomes correspond to specific learning activities. It may be noted that the above approaches may be used by a user who may be an instructor associated with an educational institution. In one example, the learning outcome may be associated with one or more learning parameters such as increased attention, improved awareness, expanded capacity for love, augmented capacity for trust, enhanced humility, and extended realization. In one example, the learning activities are categorized to obtain a target feature, with extracted feature/s from traditional arts (including but not limited to art, music, dance and theater) and traditional sports by applying the science of embodied cognition.

The examples of one or more learning activities corresponding to one or more learning pursuits have been presented in the below Table 1. However, it is pertinent to note that any number of examples may be implemented with respect to the current approaches, disclosed herein, and the same should not be construed as a limitation in any way.

TABLE 1
Example correlation of one or more learning pursuits with a target feature

| Learning | Exploring inner | | Embracing | | Deepening | |
|---|---|---|---|---|---|---|
| objectives | consciousness | | interconnectedness | | oneness | |
| Learning | Increased | Improved | Expanded | Augmented | Enhance | Extended |
| outcomes | attention | awareness | capacity | capacity | humility | realization |
| | | | for love | for trust | | |

Target feature: Body

| | | | |
|---|---|---|---|
| Learning pursuits: | Learning activities: | Learning activities: | Integration of all |
| Art learning | Creating a body map; | Storytelling (worlds | the activities |
| pursuit | practicing mandala; | meeting); Moving henna | |
| | drawing henna | (giving and receiving) | |
| Music learning | Learning activities: | Learning activities: | |
| pursuit | Listen to sounds in | Group body percussion, | |
| | nature; awareness | Nada yoga | |
| | through the body | | |
| Dance learning | Learning activities: | Learning activities: | |
| pursuit | Belly dance; | Traditional Thai bamboo | |
| | Karakattam | dance; Punjabi bhangra | |
| Theatrical | Learning activities: | Learning activities: | |
| learning pursuit | Kathakali - ancient | Group koothu theatre | |
| | facial expressions | | |
| Sports/exercise | Learning activities: | Learning activities: | |
| learning pursuit | Asanas - postures of | Acro yoga | |
| | yoga | | |

Target feature: Mind

| | | |
|---|---|---|
| Learning pursuits: | Learning activities: | Learning activities: Half |
| Art learning | Cartoon journaling; | mandala in pairs; |
| pursuit | making beads or idols | Beads exchange |
| Music learning | Learning activities: | Learning activities: |
| pursuit | Creating music | Drumming circle, |
| | instruments | ensemble of everyday/ |
| | | recycled objects |
| Dance learning | Learning activities: | Learning activities: |
| pursuit | Odissi; or Capoeira | Ethiopian shoulder dance |
| Theatrical | Learning activities: | Learning activities: |
| learning pursuit | Mime theatre | Improv theatre, shadow |
| | | theatre |
| Sports/exercise | Learning activities: | Learning activities: |
| learning pursuit | Ancient martial arts - | Kabbadi; Thai Takraw; |
| | Silambam; Tai Chi | Ethiopian genna |

Target feature: Heart

| | | |
|---|---|---|
| Learning pursuits: | Learning activities: | Learning activities: Blind |
| Art learning | Visualizing emotions; | contours (Nature; person) |
| pursuit | life map | |
| Music learning | Learning activities: | Learning activities: Om |
| pursuit | Fado; Carnatic Vocal | choir, Dhrupad |
| Dance learning | Flamenco | Salsa; Tango; Halay |
| pursuit | | |
| Theatrical | Learning activities: | Learning activities: |
| learning pursuit | Spoken word poetry | Exquisite corpse |
| | | poetry, Navarasa |
| | | theatre |
| Sports/exercise | Learning activities: | Learning activities: Thai |
| learning pursuit | Aqua yoga | boxing |

Target feature: Spirit/Soul

| | | |
|---|---|---|
| Learning pursuits: | Learning activities: | Learning activities: |
| Art learning | Affirmations/ | Group altar-making |
| pursuit | Ephemeral | |
| | art/Iconography | |
| Music learning | Learning activities: | Learning activities: |
| pursuit | Chanting | Sound bath |
| Dance learning | Learning activities: | Learning activities: |
| pursuit | Ancient dances such | Sacred circle dance; |
| | as Theyyam | Sufi whirling |
| Theatrical | Learning activities: | Learning activities: |
| learning pursuit | Make and express | Mythological dance |
| | through, masks | drama |
| Sports/exercise | Learning activities: | Learning activities: Full |
| learning pursuit | Prayanam; Vipassana | moon walks in nature |

The aspects of the present subject matter may be implemented in educational institutions, such as schools, and universities, wherein the above examples may be inculcated in a curriculum of the students so as to achieve dynamic intellectual stimulation or enhanced essential and creative thinking skills which may help the students later in their lives.

The above and other features, aspects, and advantages of the subject matter will be better explained with regard to the following description and accompanying figures. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference features and components.

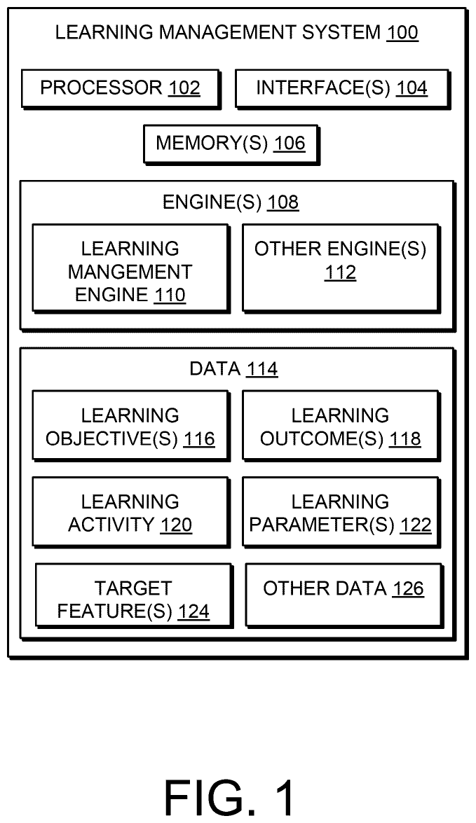

FIG. 1 illustrates an example learning management system 100 (hereinafter system 100) for implementing targeted learning, is described. Examples of system 100 include, but are not limited to a portable computer, laptops, mobile phones, notebooks and other type of computing system. The system 100 includes a processor 102, interface(s) 104, and memory(s) 106. The processor 102 may be implemented as microprocessors, microcomputers, microcontrollers, digital signal processors, central processing units, state machines, logic circuitries, and/or other devices that manipulate signals based on operational instructions. Among other capabilities, the processor(s) 102 is configured to fetch and execute computer-readable instructions stored in the memory(s) 104 for implementing targeted learning. The interface(s) 104 may allow the connection or coupling of the system 100 with one or more other devices, through a wired (e.g., Local Area Network, i.e., LAN) connection or through a wireless connection (e.g., Bluetooth®, Wi-Fi). The interface(s) 104 may also enable intercommunication between different logical as well as hardware components of the system 100.

The memory(s) 106 may be a computer-readable medium, examples of which include volatile memory (e.g., RAM), and/or non-volatile memory (e.g., Erasable Programmable read-only memory, i.e., EPROM, flash memory, etc.). The memory(s) 106 may be an external memory, or internal memory, such as a flash drive, a compact disk drive, an external hard disk drive, or the like. The memory(s) 106 may further include data which either may be utilized or generated during the operation of the system 100.

The system 100 may further include engine(s) 108 and data 114. The engine(s) 108 may be implemented as a combination of hardware and programming, for example, programmable instructions to implement a variety of functionalities of the engine(s) 108. In examples described herein, such combinations of hardware and programming may be implemented in several different ways. For example, the programming for the engine(s) 108 may be executable instructions. Such instructions may be stored on a non-transitory machine-readable storage medium which may be coupled either directly with the system 100 or indirectly (for example, through networked means). In an example, the engine(s) 108 may include a processing resource, for example, either a single processor or a combination of multiple processors, to execute such instructions. In the present examples, the non-transitory machine-readable storage medium may store instructions that, when executed by the processing resource, implement engine(s) 108. In other examples, the engine(s) 108 may be implemented as electronic circuitry.

The engine(s) 108 includes a learning management engine 110 and other engine(s) 112. The other engine(s) 112 may further implement functionalities that supplement functions performed by the system 100 or any of the engine(s) 108. The data 114, on the other hand, includes data that is either stored or generated as a result of functions implemented by any of the engine(s) 108 or the system 100. It may be further noted that information stored and available in data 114 may be utilized by the engine(s) 108 for performing various functions by the system 100. In an example, data 114 may include learning objective(s) data 116, learning outcome(s) data 118, learning activity data 120, learning parameter(s) data 122, target feature(s) data 124, and other data 126. It may be noted that such examples are only indicative. The present approaches may be applicable to other examples without deviating from the scope of the present subject matter.

In an example, the learning management engine 110 may be initiated to select a one or more learning outcome(s) 118 from the data 114 associated with the learning management system 100. In one example, the learning outcome(s) 118 may correspond to obtaining a learning objective stored as learning objective(s) data 116. However, for obtaining the learning objective, the learning management system 100 may be initiated to identify one or more learning activities stored as learning activity 120 in the data 114. It may be noted that each learning activity data 120 is associated with the learning objective(s) data 116.

Continuing further, the learning management system 100 may categorize the one or more learning activities from the learning activity data 120 based on one of a type, a form, and a prospect of the learning activity. In one example, the learning activities are categorized to obtain a target feature which may be stored as target feature(s) data 124 and may be associated with an ambit comprising body, mind, heart, and spirit of a user utilizing the learning management system 100. It may be noted that the user referred to in the present subject matter may be an instructor associated with the educational institution and wherein the user facilitates the students to undergo targeted learning by way of the implementing the learning management system 100. In one example, the learning activities are categorized to obtain a target feature, with extracted feature/s from traditional arts (including but not limited to art, music, dance and theater) and traditional sports by applying the science of embodied cognition.

Further, the learning management system 100 may correlate each of the plurality of learning activities stored as learning activity 120 in the data 114 with each of the target features stored as target feature(s) data 124 based on a pre-defined criterion, wherein correlating the learning activity with the target feature corresponds to activating the target feature based on the learning activity, which ultimately leads to obtaining the learning objective. The pre-defined criterion for correlating the learning activity with the target feature corresponds to determining whether the learning activity comprises an individual or a group of individuals, for example, whether a single student may be able to perform the learning activity, or a group of students are required to perform the learning activity. In one example, the learning management system 100 may retrieve data from a global repository (not shown in FIG. 1), wherein the global repository is a storage area comprising one or more of the learning activities and their relevance to a school curriculum. The learning management system may be configured to utilize data retrieved from the global repository, to establish a correlation between the one or more learning pursuits with the target feature.

In one example, the type, form, and prospect of the learning activity may correspond to determining whether the learning activity is one of a performance, an enactment, a ceremony, a ritual, or combinations thereof. In one example, the learning activity may correspond to a learning pursuit selected from one of an art learning pursuit, a music learning pursuit, a dance learning pursuit, a theatrical learning pursuit, a sports learning pursuit, or combinations thereof. In one example, the learning outcome may be associated with one or more learning parameters stored as learning parameter(s) data 122 comprising an increased attention, an improved awareness, an expanded capacity for love, an augmented capacity for trust, an enhanced humility, and an extended realization, wherein the learning parameters are related to the learning objective selected by the system 100.

In operation, following the categorization of the one or learning activities by the system 100 corresponding to the one or more learning pursuit, it may be determined whether the learning pursuit involves an individual user or involves one or more users. For example, if a user intends to activate the target feature of body, and intends to achieve a target learning objective of inner consciousness which is essentially related to an individual learning activity, for example, respective to a student, the user may initiate the learning management system 100 to further select a target learning outcome, for example, increased attention. Now, in respect to improved attention, the user may select, for example, the dance learning pursuit. As a result of correlating the learning pursuit with the target learning outcome, the learning management system 100 may suggest a learning activity of, for example, belly dance, by utilizing pre-stored instructions. As may be understood, belly dance corresponds to a specific body part and performing belly dance may lead to increased attention of the student, which in turn may enable the student to explore inner consciousness.

In another example, if a user intends to activate the target feature of body, and intends to achieve a target learning objective of inter-connectedness which is essentially related to group learning activity, for example, respective to one or more students, the user may initiate the learning management system 100 to further select a target learning outcome, for example, expanded capacity for love. Now, in respect to the expanded capacity for love, the user may select, for example, the art learning pursuit. As a result of correlating the learning pursuit with the target learning outcome, the learning management system 100 may suggest a learning activity of, for example, storytelling, by utilizing pre-stored instructions. As may be understood, storytelling involves one or more people and comprises of sharing one's thoughts and ideas through their words or actions in the form of a story which may lead to expanded capacity of love of the one or more students, which in turn may enable the one or more students to embrace inter-connectedness.

In another example, if a user intends to activate the target feature of mind, and intends to achieve a target learning objective of inner-consciousness which is essentially related to an individual activity, for example, respective to a student, the user may initiate the learning management system 100 to further select a target learning outcome, for example, improved awareness. Now, in respect to improved awareness, the user may select, for example, the art learning pursuit. As a result of correlating the learning pursuit with the target learning outcome, the learning management system may suggest a learning activity of, for example, cartoon journaling, by utilizing pre-stored instructions. As may be understood, cartoon journaling involves using one's imagination and thoughts by creating an image in their minds which may lead to improved awareness of the student, which in turn may enable the student to explore inner-consciousness.

The above aspects are based on correlation of one or more learning pursuits with a target feature. Herein, the correlation is based on mapping traditional expressive cultural art forms into the emerging science of embodied cognition using a two-dimensional approach wherein a learning outcome is targeted as a goal to achieve a specific learning objective.

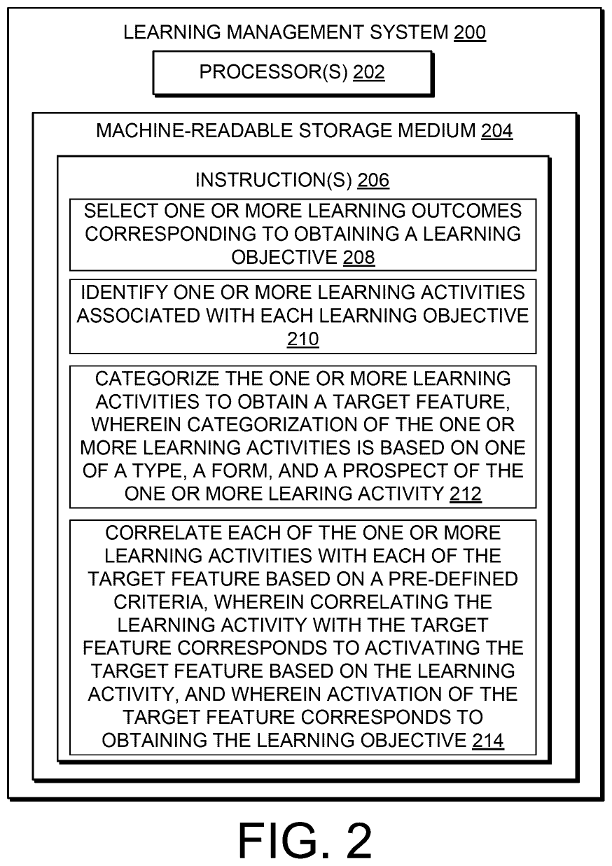

FIG. 2 illustrates a learning management system 200 for implementing targeted learning, as per one example. The system 200 includes a processor 202 and a machine-readable storage medium 204 which is coupled to, and accessible by, the processor 202. The system 200 may be implemented in any computing system, such as a storage array, server, desktop or a laptop computing device, a distributed computing system, or the like. Although not depicted, the system 200 may include other components, such as interfaces to communicate over the network or with external storage or computing devices, display, input/output interfaces, operating systems, applications, data, and other software or hardware components (all of which have not been depicted).

The processor 202 may be implemented as a dedicated processor, a shared processor, or a plurality of individual processors, some of which may be shared. The machine-readable storage medium 204 may be communicatively connected to the processor 202. Among other capabilities, the processor 202 may fetch and execute computer-readable instructions, including instructions 206, stored in the machine-readable storage medium 204. The machine-readable storage medium 204 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device. In an example, the processor 202 may fetch and execute instructions 206. In one example, as a result of the execution of the instructions 208, the system 200 may select a one or more learning outcome(s) from the database associated with the learning management system 200. In one example, the learning outcome(s) may correspond to obtaining a learning objective stored as learning objective(s) data. Once selected, the instructions 210 may be executed wherein one or more learning activities may be identified, wherein the one or more learning activities when identified may be associated with each learning objective.

Continuing further, the instruction 212 may be executed wherein the one or more learning activities may be categorized based on one of a type, a form, and a prospect of the learning activity. In one example, the learning activities are categorized to obtain a target feature and may be associated with an ambit comprising body, mind, heart, and spirit of a user utilizing the learning management system 200. It may be noted that the user referred to in the present subject matter may be an instructor associated with the educational institution and wherein the user facilitates the students to undergo targeted learning by way of the implementing the learning management system 200.

Further, the instruction 214 may be executed wherein each of the plurality of learning activities may be correlated with each of the target features based on a pre-defined criterion, wherein correlating the learning activity with the target feature corresponds to activating the target feature based on the learning activity, which ultimately leads to obtaining the learning objective. The pre-defined criterion for correlating the learning activity with the target feature corresponds to determining whether the learning activity comprises an individual or a group of individuals, for example, whether a single student may be able to perform the learning activity, or a group of students are required to perform the learning activity.

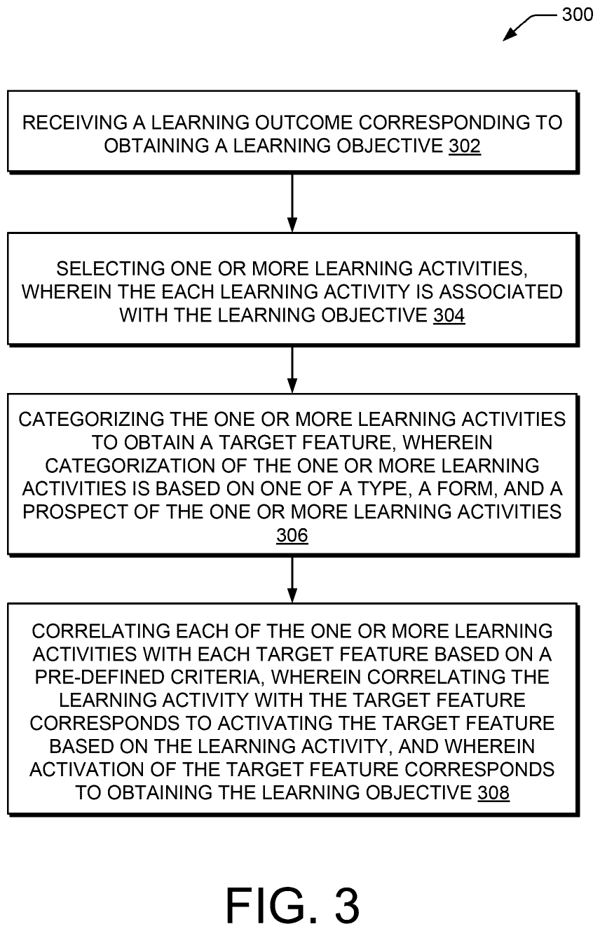

FIG. 3 illustrates a method for implementing targeted learning, for example, in an educational institution, as per another example. The order in which the above-mentioned method is described is not intended to be construed as a limitation, and some of the described method blocks may be combined in a different order to implement the method, or an alternative method. Furthermore, the above-mentioned method may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a learning management system, such as learning management system 100 or learning management system 200. In an implementation, the method may be performed under an “as a service” delivery model, where the learning management system 100 or learning management system 200, operated by a user, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 302, a learning outcome may be received. In one example, one or more learning outcome(s) from the database associated with a learning management system 100 or a learning management system 200 may be received. In one example, the learning outcome(s) may correspond to obtaining a learning objective.

At block 304, a learning activity may be selected. In one example, the system 100 or 200 may select one or more learning activities, wherein the one or more learning activities are associated with each learning objective.

At block 306, the learning activity may be categorized. In one example, the one or more learning activities may be categorized based on one of a type, a form, and a prospect of the learning activity. In one example, the learning activities are categorized to obtain a target feature and may be associated with an ambit comprising body, mind, heart, and spirit of a user utilizing the learning management system 100 or 200. It may be noted that the user referred to in the present subject matter may be an instructor associated with the educational institution and wherein the user facilitates the students to undergo targeted learning by way of the implementing the learning management system 100 or 200.

At block 308, the learning activity may be correlated. In one example, each of the plurality of learning activities may be correlated with each of the target features based on a pre-defined criterion, wherein correlating the learning activity with the target feature corresponds to activating the target feature based on the learning activity, which ultimately leads to obtaining the learning objective. The pre-defined criterion for correlating the learning activity with the target feature corresponds to determining whether the learning activity comprises an individual or a group of individuals, for example, whether a single student may be able to perform the learning activity, or a group of students are required to perform the learning activity.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

I/We claim:

1. A learning management system comprising:
a processor; and
a learning management engine coupled to the processor, wherein the learning management engine is to:
select a learning outcome from a database server associated with the learning management system, wherein the learning outcome corresponds to obtaining a learning objective, and wherein the learning management engine to select the learning outcome is to:
identify one or more learning activities with extracted features from traditional arts and traditional sports by applying the science of embodied cognition, wherein each learning activity is associated with the learning objective;
categorize the one or more learning activities to determine a target feature, wherein categorization of the one or more learning activities is based on one of a type, a form, a prospect of the one or more learning activities;
correlate each of the one or more learning activities with each of the target feature based on a pre-defined criterion, wherein correlating the learning activity with the target feature corresponds to activating the target feature based on the learning activity, and wherein activation the target feature corresponds to obtaining the learning objective.

2. The system as claimed in claim 1, wherein the pre-defined criterion for correlating the learning activity with the target feature is determined based on whether the learning activity comprises of an individual or a group of individuals.

3. The system as claimed in claim 1, wherein the type, form, and prospect of the one or more learning activities corresponds to determining whether the learning activity is one of a performance, an enactment, a ceremony, a ritual, or combinations thereof.

4. The system as claimed in claim 1, wherein the target feature is associated with an ambit comprising body, mind, heart, and spirit of a user corresponding to the system.

5. The system as claimed in claim 3, wherein the learning activity corresponds to a learning pursuit selected from one of an art learning pursuit, a music learning pursuit, a dance learning pursuit, a theatrical learning pursuit, a sports learning pursuit, or combinations thereof.

6. The system as claimed in claim 1, wherein the learning outcome is associated with one or more learning parameters comprising an increased attention, an improved awareness, an expanded capacity for love, an augmented capacity for trust, an enhanced humility, and an extended realization, wherein the learning parameters are related to the learning objective selected by the system.

7. A method comprising:
receiving, by a learning management system, a learning outcome from a database server associated with the learning management system, wherein the learning outcome corresponds to a learning objective, and wherein receiving the learning outcome comprises:
selecting, by the learning management system, one or more learning activities, wherein each learning activity is associated with the learning objective;
categorizing, by the learning management system, the one or more learning activities to obtain a target feature, wherein categorization of the one or more learning activities is based on one of a type, a form, a prospect of the one or more learning activities;
correlating, by the learning management system, each of the one or more learning activities with each of the target feature based on a pre-defined criterion, wherein correlating the learning activity with the target feature corresponds to activating the target feature based on the learning activity, and wherein activation the target feature corresponds to obtaining the learning objective.

8. The method as claimed in claim 7, wherein the pre-defined criterion for correlating the learning activity with the target feature is determined based on whether the learning activity comprises of an individual or a group of individuals.

9. The method as claimed in claim 7, wherein the type, form, and prospect of the one or more learning activities corresponds to determining whether the learning activity is one of a performance, an enactment, a ceremony, a ritual, or combinations thereof.

10. The method as claimed in claim 7, wherein the target feature is associated with an ambit comprising body, mind, heart, and spirit of a user corresponding to the system.

11. The method as claimed in claim 7, wherein the target feature is associated with an ambit comprising body, mind, heart, and spirit of a user corresponding to the system.

12. The method as claimed in claim 9, wherein the learning activity corresponds to a learning pursuit selected from one of an art learning pursuit, a music learning pursuit, a dance learning pursuit, a theatrical learning pursuit, a sports learning pursuit, or combinations thereof.

13. The method as claimed in claim 7, wherein the learning outcome is associated with one or more learning parameters comprising an increased attention, an improved awareness, an expanded capacity for love, an augmented capacity for trust, an enhanced humility, and an extended realization, wherein the learning parameters are related to the learning objective selected by the system.
